(19) United States
(12) Patent Application Publication
(10) Pub. No.: US 2026/0302799 A1
(43) Pub. Date: Oct. 1, 2026

(54) ELECTRIC APPARATUS

(71) Applicant: HONDA MOTOR CO., LTD., Tokyo (JP)

(72) Inventors: Keiya Nimura, Tokyo (JP); Yoshihisa Kubota, Tokyo (JP)

(21) Appl. No.: 19/533,553

(22) Filed: Feb. 9, 2026

(30) Foreign Application Priority Data
Mar. 28, 2025 (JP) 2025-055359

(51) Int. Cl. H02J 7/14; B60L 50/64; H02M 3/44

(52) U.S. Cl. CPC H02J 7/1492; B60L 50/64; H02M 3/44

(57) ABSTRACT

An electric apparatus includes: an electric power control unit that controls electric power transfer of each of an electric power storage device and a rotary electric machine; a DC charging terminal that connects the electric power control unit to an external DC electric power source; and a position sensor that detects a rotor angle of the rotary electric machine. The electric power control unit includes a first full-bridge circuit connected to both ends of a first coil, a second full-bridge circuit connected to both ends of a second coil, and a control device. The control device controls the first full-bridge circuit and the second full-bridge circuit such that electric power is supplied to one of the first coil and the second coil based on the rotor angle obtained from an output signal of the position sensor at a time of DC charging in which the electric power storage device is charged by electric power supplied from the external DC electric power source.

### CROSS-REFERENCE TO RELATED APPLICATION

Priority is claimed on Japanese Patent Application No. 2025-055359, filed on Mar. 28, 2025, the contents of which are incorporated herein by reference.

### BACKGROUND

### Field of the Invention

The present invention relates to an electric apparatus.

### Background

In recent years, in order to ensure that more people have access to affordable, reliable, sustainable, and advanced energy, research and development relating to charging and electric power supply in a mobility on which a secondary battery is mounted, which contributes to energy efficiency, has been conducted.

In the related art, for example, an electric vehicle is known which converts AC electric power supplied from an external electric power source into DC electric power by a combination of stator windings of a plurality of phases of a motor and bridge circuits of a plurality of phases by switching elements (for example, refer to Japanese Unexamined Patent Application, First Publication No. 2012-70613). In this electric vehicle, by a current from the external electric power source being supplied to a connection point that divides the stator winding of each phase into two, magnetic fluxes in a magnetic circuit of the motor cancel each other, and generation of a torque is prevented.

### SUMMARY

In the technique relating to charging and electric power supply in a mobility on which a secondary battery is mounted, it is a problem to improve the charging efficiency of DC charging by the external electric power source, but in the conventional technique described above, there is room for improvement from the viewpoint of improving the charging efficiency of DC charging.

The present application aims at achieving an improvement of the charging efficiency at the time of DC charging. Further, the present application contributes to energy efficiency.

An electric apparatus according to a first aspect of the present invention includes: an electric power storage device; a rotary electric machine; an electric power control unit that is connected to the electric power storage device and the rotary electric machine and controls electric power transfer of each of the electric power storage device and the rotary electric machine; a DC charging terminal that connects the electric power control unit to an external DC electric power source; and a position sensor that detects a rotation angle of a rotor of the rotary electric machine as a rotor angle, wherein the rotary electric machine includes a first coil and a second coil that have a phase which is orthogonal to each other, the electric power control unit includes a first full-bridge circuit connected to both ends of the first coil, a second full-bridge circuit connected to both ends of the second coil, and a control device that controls the first full-bridge circuit and the second full-bridge circuit, and the control device controls the first full-bridge circuit and the second full-bridge circuit such that electric power is supplied to one of the first coil and the second coil based on the rotor angle obtained from an output signal of the position sensor at a time of DC charging in which the electric power storage device is charged by electric power supplied from the external DC electric power source.

A second aspect is the electric apparatus according to the first aspect described above, wherein the first coil may be constituted by connecting a third coil and a fourth coil in series in a state where the third coil and the fourth coil are coupled in an identical direction, the second coil may be constituted by connecting a fifth coil and a sixth coil in series in a state where the fifth coil and the sixth coil are coupled in an identical direction, a positive electrode of the DC charging terminal may be connected to each of a connection point between the third coil and the fourth coil and a connection point between the fifth coil and the sixth coil, and a negative electrode of the DC charging terminal may be connected to a negative electrode of the electric power storage device.

A third aspect is the electric apparatus according to the first aspect described above, wherein at the time of the DC charging, the control device may control the first full-bridge circuit and the second full-bridge circuit such that electric power is supplied to both of the first coil and the second coil when charging electric power is equal to or more than an electric power threshold value and may control the first full-bridge circuit and the second full-bridge circuit such that electric power is supplied to one of the first coil and the second coil when the charging electric power is less than the electric power threshold value.

A fourth aspect is the electric apparatus according to any one of the first to third aspects described above, wherein the first coil may be constituted of the third coil and the fourth coil in which a middle point of the first coil is a boundary, and the third coil and the fourth coil may be wound around an identical slot in the rotary electric machine.

A fifth aspect is the electric apparatus according to the fourth aspect described above, wherein the second coil may be constituted of the fifth coil and the sixth coil in which a middle point of the second coil is a boundary, the fifth coil and the sixth coil may be wound around a different slot of an identical phase in the rotary electric machine, and when controlling the first full-bridge circuit and the second full-bridge circuit such that electric power is supplied to the second coil among the first coil and the second coil at the time of DC charging, the control device may control the first full-bridge circuit and the second full-bridge circuit such that a current flows in a direction in which a magnetic field is cancelled with respect to the rotor.

An electric apparatus according to a sixth aspect of the present invention includes: an electric power storage device; a rotary electric machine; an electric power control unit that is connected to the electric power storage device and the rotary electric machine and controls electric power transfer of each of the electric power storage device and the rotary electric machine; and a DC charging terminal that connects the electric power control unit to an external DC electric power source, wherein the rotary electric machine includes a first coil and a second coil that have a phase which is orthogonal to each other, the electric power control unit includes a first full-bridge circuit connected to both ends of the first coil, a second full-bridge circuit connected to both ends of the second coil, and a control device that controls the first full-bridge circuit and the second full-bridge circuit, and at a time of the DC charging in which the electric power storage device is charged by electric power supplied from the external DC electric power source, the control device controls the first full-bridge circuit and the second full-bridge circuit such that electric power is supplied to both of the first coil and the second coil when charging electric power is equal to or more than an electric power threshold value and controls the first full-bridge circuit and the second full-bridge circuit such that electric power is supplied to one of the first coil and the second coil when the charging electric power is less than the electric power threshold value.

According to the first aspect, at the time of DC charging, the electric power storage device can be charged by using a coil of a phase having a relatively high charging efficiency among the first coil and the second coil in accordance with the rotor angle of the rotary electric machine, and therefore, it is possible to improve the charging efficiency at the time of DC charging.

According to the second aspect, since an iron loss is reduced by a current flowing in a direction in which each of the first coil and the second coil cancels a magnetic flux, the charging efficiency is improved, and it is possible to prevent a charging torque from being generated.

According to the third aspect, since charging is performed by supplying electric power to one of the first coil and the second coil in a region where the charging electric power is relatively low and charging is performed by supplying electric power to both of the first coil and the second coil in a region where the charging electric power is relatively high, it is possible to maintain a high charging efficiency over the entire region of the charging electric power.

According to the fourth aspect, by employing a structure in which the third coil and the fourth coil are wound around the identical slot in the rotary electric machine, a magnetic coupling degree between the third coil and the fourth coil can be enhanced, and therefore, it is possible to improve the charging efficiency.

According to the fifth aspect, it is possible to prevent a charging torque from being generated at the rotary electric machine while structurally ensuring the inductance of the rotary electric machine.

According to the sixth aspect, since charging is performed by supplying electric power to one of the first coil and the second coil in a region where the charging electric power is relatively low, and charging is performed by supplying electric power to both of the first coil and the second coil in a region where the charging electric power is relatively high, it is possible to maintain a high charging efficiency over the entire region of the charging electric power.

### BRIEF DESCRIPTION OF THE DRAWINGS

FIG. 1 is a view showing a schematic configuration of an electric apparatus according to an embodiment.

FIG. 2 is a view schematically showing a configuration of a rotary electric machine of the electric apparatus according to the embodiment.

FIG. 3 is a view showing a path of a charging current that flows in the electric apparatus when α-phase charging is performed.

FIG. 4 is a view showing a path of a charging current that flows in the electric apparatus when β-phase charging is performed.

FIG. 5 is a view showing a path of a charging current that flows in the electric apparatus when two-phase charging is performed.

FIG. 6 is a view showing a correspondence relationship between charging electric power and a charging efficiency.

FIG. 7 is a view showing a correspondence relationship between a rotor angle and a charging efficiency.

FIG. 8 is a flowchart showing a charging control process performed by an electronic control unit of the electric apparatus according to the embodiment.

FIG. 9 is a flowchart showing a modification example of a charging control process performed by the electronic control unit of the electric apparatus according to the embodiment.

### DESCRIPTION OF EMBODIMENTS

Hereinafter, an embodiment of an electric apparatus according to the present invention will be described with reference to the drawings.

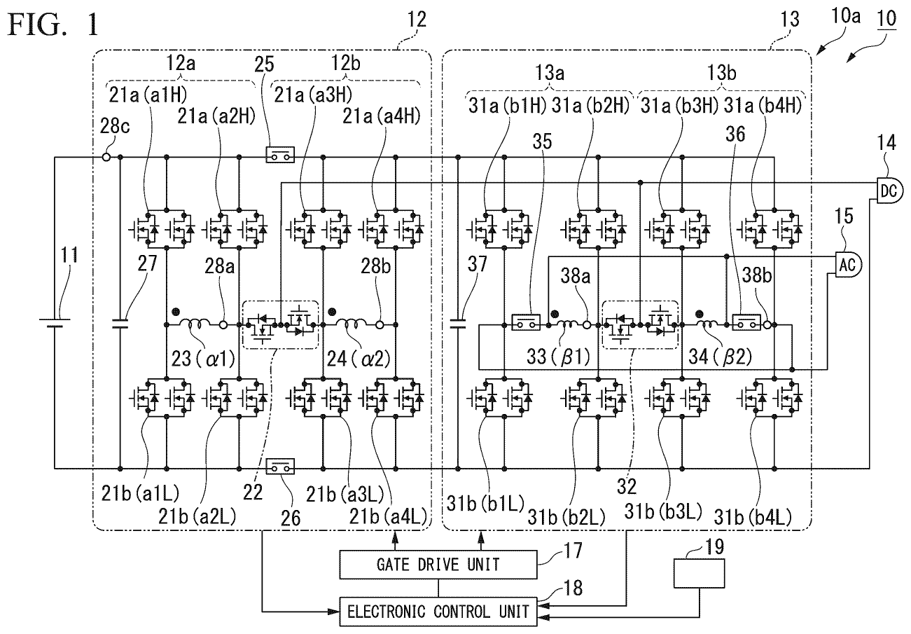

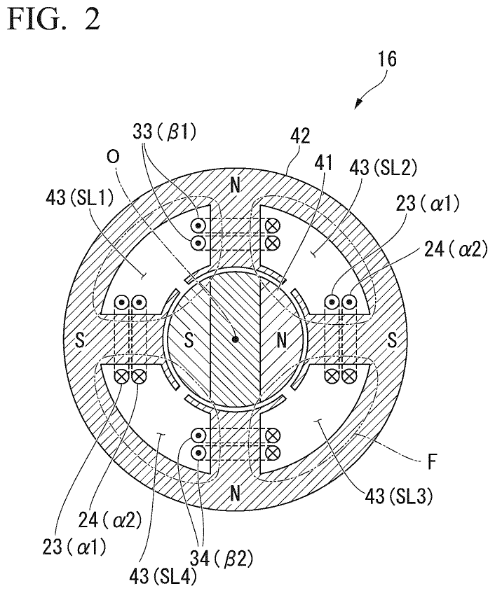

FIG. 1 is a view showing a schematic configuration of an electric apparatus 10 according to the present embodiment. FIG. 2 is a view schematically showing a configuration of a rotary electric machine 16 of the electric apparatus 10.

The electric apparatus 10 is mounted, for example, on an electric vehicle, an electric movable body, an electric machine, an electric power source device, and the like. The electric vehicle is, for example, an electric automobile that includes a rotary electric machine as a power source, a saddle riding vehicle, a kick skater, a hybrid vehicle by a combination of a rotary electric machine and an internal combustion engine, a fuel cell vehicle by a combination of an electric power storage device and a fuel cell, and the like. The electric movable body is, for example, a robot, a flying vehicle, a movable body on water, an underwater movable body, and the like. The electric machine is, for example, a construction machine that includes a rotary electric machine as a power source and the like. The electric power source device is, for example, a stationary or mobile electric power source device that performs discharging and charging of an electric power storage device and the like.

### Electric Apparatus

As shown in FIG. 1 and FIG. 2, the electric apparatus 10 includes, for example, an electric power storage device 11, a first electric power conversion portion 12, a second electric power conversion portion 13, a DC charging terminal 14, an AC charging terminal 15, a rotary electric machine 16, a gate drive unit 17, an electronic control unit 18 (control device), and a position sensor 19. For example, the first electric power conversion portion 12, the second electric power conversion portion 13, the DC charging terminal 14, the AC charging terminal 15, the gate drive unit 17, and the electronic control unit 18 constitute an electric power control unit 10a.

The electric power storage device 11 is connected to the first electric power conversion portion 12 and the second electric power conversion portion 13 described later.

The electric power storage device 11 includes, for example, a plurality of battery cells that are connected in series or in parallel. Each battery cell is, for example, a lead storage battery, a lithium-ion battery, a secondary battery such as a nickel hydride battery and an all-solid-state battery, a capacitor such as an electric double layer capacitor, a compound battery by a combination of a secondary battery and a capacitor, or the like. Each battery cell repeatedly performs charging and discharging.

The electric power storage device 11 transfers electric power to and from the rotary electric machine 16 via the electric power control unit 10a. The electric power storage device 11 is charged by an external electric power source (an external DC electric power source and an external AC electric power source).

The first electric power conversion portion 12 includes a first full-bridge circuit 12a and a second full-bridge circuit 12b. Each of the first full-bridge circuit 12a and the second full-bridge circuit 12b includes, for example, a so-called H-bridge circuit formed of a plurality of switching elements connected in two phases by bridge connection. Each switching element included in the first full-bridge circuit 12a and the second full-bridge circuit 12b is, for example, a transistor of a SiC (Silicon Carbide) or the like, such as a MOSFET (Metal Oxide Semi-conductor Field Effect Transistor) or an IGBT (Insulated Gate Bipolar Transistor). Each switching element included in the first full-bridge circuit 12a and the second full-bridge circuit 12b is, for example, an N-channel type MOSFET.

The plurality of switching elements included in the first full-bridge circuit 12a and the second full-bridge circuit 12b are, for example, a pair of transistors forming each of high-side arm and low-side arm element portions 21a, 21b that form a pair in each phase. Each pair of transistors of each element portion 21a, 21b is connected, for example, in parallel. Each full-bridge circuit 12a, 12b may include, for example, a rectifier element such as a reflux diode which is connected in parallel between a collector and an emitter of each transistor in a forward direction toward the collector from the emitter.

The first electric power conversion portion 12 includes, for example, a first switch 22 that is connected between a second middle point of the first full-bridge circuit 12a and a third middle point of the second full-bridge circuit 12b. The second middle point of the first full-bridge circuit 12a is, for example, a connection point between a high-side arm element portion 21a (a2H) and a low-side arm element portion 21b (a2L) that are connected in series in a second phase among first and second phases of two phases of the first full-bridge circuit 12a. For example, the second middle point of the first full-bridge circuit 12a is a connection point between a source of the high-side arm element portion 21a (a2H) and a drain of the low-side arm element portion 21b (a2L).

The third middle point of the second full-bridge circuit 12b is, for example, a connection point between a high-side arm element portion 21a (a3H) and a low-side arm element portion 21b (a3L) that are connected in series in a first phase among first and second phases of two phases of the second full-bridge circuit 12b. For example, the third middle point of the second full-bridge circuit 12b is a connection point between a source of the high-side arm element portion 21a (a3H) and a drain of the low-side arm element portion 21b (a3L).

The first switch 22 is, for example, a bidirectional switch formed of two switching elements. Each switching element included in the first switch 22 is a transistor such as a MOSFET or an IGBT and is, for example, an N-channel type MOSFET. The first switch 22 includes, for example, two transistors connected reversely in series. For example, the sources of the two transistors are connected to each other, and thereby, the two transistors are connected in series in a direction opposite to each other. The first switch 22 switches conduction and cutoff of a current between the second middle point of the first full-bridge circuit 12a and the third middle point of the second full-bridge circuit 12b by ON (conduction)/OFF (cutoff) of the two transistors.

Each transistor included in the first switch 22 may include a rectifier element such as a reflux diode which is connected in parallel between a collector and an emitter in a forward direction toward the collector from the emitter.

The first electric power conversion portion 12 is connected to an α-phase first coil 23 (α1) (third coil) and an α-phase second coil 24 (α2) (fourth coil) of the rotary electric machine 16 described later. The α-phase first coil 23 (α1) is connected between a first middle point and the second middle point in the first full-bridge circuit 12a. The first middle point of the first full-bridge circuit 12a is, for example, a connection point between a high-side arm element portion 21a (a1H) and a low-side arm element portion 21b (a1L) that are connected in series in the first phase of the first full-bridge circuit 12a. For example, the first middle point of the first full-bridge circuit 12a is a connection point between a source of the high-side arm element portion 21a (a1H) and a drain of the low-side arm element portion 21b (a1L).

The α-phase second coil 24 (α2) is connected between the third middle point and a fourth middle point in the second full-bridge circuit 12b. The fourth middle point of the second full-bridge circuit 12b is, for example, a connection point between a high-side arm element portion 21a (a4H) and a low-side arm element portion 21b (a4L) that are connected in series in the second phase of the second full-bridge circuit 12b. For example, the fourth middle point of the second full-bridge circuit 12b is a connection point between a source of the high-side arm element portion 21a (a4H) and a drain of the low-side arm element portion 21b (a4L).

The first electric power conversion portion 12 includes a first connection-disconnection device 25 that is connected between positive electrodes of the first full-bridge circuit 12a and the second full-bridge circuit 12b and a second connection-disconnection device 26 that is connected between negative electrodes of the first full-bridge circuit 12a and the second full-bridge circuit 12b. Each of the first connection-disconnection device 25 and the second connection-disconnection device 26 is, for example, a contactor and switches between ON and OFF of the connection between the first full-bridge circuit 12a and the second full-bridge circuit 12b.

The first electric power conversion portion 12 includes, for example, a first capacitor (condenser) 27 that is connected between the positive electrode and the negative electrode. For example, the first capacitor 27 smooths voltage variation generated in accordance with a switching operation between ON and OFF of each switching element of the first electric power conversion portion 12.

The first electric power conversion portion 12 includes a first current sensor 28a, a second current sensor 28b, and a third current sensor 28c. For example, the first current sensor 28a is arranged between the α-phase first coil 23 (α1) and the second middle point of the first full-bridge circuit 12a. The second current sensor 28b is arranged between the α-phase second coil 24 (α2) and the fourth middle point of the second full-bridge circuit 12b. The third current sensor 28c is arranged between the electric power storage device 11 and the first electric power conversion portion 12.

For example, the first current sensor 28a detects a current that flows through the α-phase first coil 23 (α1). The second current sensor 28b detects a current that flows through the α-phase second coil 24 (α2). The third current sensor 28c detects a current that flows between the first electric power conversion portion 12 and the electric power storage device 11.

The second electric power conversion portion 13 includes a third full-bridge circuit 13a and a fourth full-bridge circuit 13b. Each of the third full-bridge circuit 13a and the fourth full-bridge circuit 13b includes, for example, an H-bridge circuit formed of a plurality of switching elements connected in two phases by bridge connection. Each switching element included in the third full-bridge circuit 13a and the fourth full-bridge circuit 13b is, for example, a transistor of a SiC or the like, such as a MOSFET or an IGBT. Each switching element included in the third full-bridge circuit 13a and the fourth full-bridge circuit 13b is, for example, an N-channel type MOSFET.

The plurality of switching elements included in the third full-bridge circuit 13a and the fourth full-bridge circuit 13b are, for example, a pair of transistors forming each of high-side arm and low-side arm element portions 31a, 31b that form a pair in each phase. Each pair of transistors of each element portion 31a, 31b are connected, for example, in parallel.

Each full-bridge circuit 13a, 13b may include, for example, a rectifier element such as a reflux diode which is connected in parallel between a collector and an emitter of each transistor in a forward direction toward the collector from the emitter.

The second electric power conversion portion 13 includes, for example, a second switch 32 that is connected between a sixth middle point of the third full-bridge circuit 13a and a seventh middle point of the fourth full-bridge circuit 13b. The sixth middle point of the third full-bridge circuit 13a is, for example, a connection point between a high-side arm element portion 31a (b2H) and a low-side arm element portion 31b (b2L) that are connected in series in a second phase among first and second phases of two phases of the third full-bridge circuit 13a. For example, the sixth middle point of the third full-bridge circuit 13a is a connection point between a source of the high-side arm element portion 31a (b2H) and a drain of the low-side arm element portion 31b (b2L).

The seventh middle point of the fourth full-bridge circuit 13b is, for example, a connection point between a high-side arm element portion 31a (b3H) and a low-side arm element portion 31b (b3L) that are connected in series in a first phase among first and second phases of two phases of the fourth full-bridge circuit 13b. For example, the seventh middle point of the fourth full-bridge circuit 13b is a connection point between a source of the high-side arm element portion 31a (b3H) and a drain of the low-side arm element portion 31b (b3L).

The second switch 32 is, for example, a bidirectional switch formed of two switching elements. Each switching element included in the second switch 32 is a transistor such as a MOSFET or an IGBT and is, for example, an N-channel type MOSFET. The second switch 32 includes, for example, two transistors connected reversely in series. For example, the sources of the two transistors are connected to each other, and thereby, the two transistors are connected in series in a direction opposite to each other. The second switch 32 switches conduction and cutoff of a current between the sixth middle point of the third full-bridge circuit 13a and the seventh middle point of the fourth full-bridge circuit 13b by ON/OFF of the two transistors.

Each transistor included in the second switch 32 may include a rectifier element such as a reflux diode which is connected in parallel between a collector and an emitter in a forward direction toward the collector from the emitter.

The second electric power conversion portion 13 is connected to a β-phase first coil 33 (β1) (fifth coil) and a β-phase second coil 34 (β2) (sixth coil) of the rotary electric machine 16 described later. The β-phase first coil 33 is connected between a fifth middle point and the sixth middle point in the third full-bridge circuit 13a. The fifth middle point of the third full-bridge circuit 13a is, for example, a connection point between a high-side arm element portion 31a (b1H) and a low-side arm element portion 31b (b1L) that are connected in series in the first phase of the third full-bridge circuit 13a. For example, the fifth middle point of the third full-bridge circuit 13a is a connection point between a source of the high-side arm element portion 31a (b1H) and a drain of the low-side arm element portion 31b (b1L).

The β-phase second coil 34 (β2) is connected between the seventh middle point and an eighth middle point in the fourth full-bridge circuit 13b. The eighth middle point of the fourth full-bridge circuit 13b is, for example, a connection point between a high-side arm element portion 31a (b4H) and a low-side arm element portion 31b (b4L) that are connected in series in the second phase of the fourth full-bridge circuit 13b. For example, the eighth middle point of the fourth full-bridge circuit 13b is a connection point between a source of the high-side arm element portion 31a (b4H) and a drain of the low-side arm element portion 31b (b4L).

The second electric power conversion portion 13 includes a third connection-disconnection device 35 and a fourth connection-disconnection device 36. The third connection-disconnection device 35 is connected between the β-phase first coil 33 (β1) and the fifth middle point of the third full-bridge circuit 13a. The fourth connection-disconnection device 36 is connected between the β-phase second coil 34 (β2) and the eighth middle point of the fourth full-bridge circuit 13b. Each of the third connection-disconnection device 35 and the fourth connection-disconnection device 36 is, for example, a contactor. The third connection-disconnection device 35 switches between ON and OFF of the connection between the β-phase first coil 33 (β1) and the fifth middle point of the third full-bridge circuit 13a. The fourth connection-disconnection device 36 switches between ON and OFF of the connection between the β-phase second coil 34 (β2) and the eighth middle point of the fourth full-bridge circuit 13b.

The second electric power conversion portion 13 includes, for example, a second capacitor (condenser) 37 that is connected between the positive electrode and the negative electrode. For example, the second capacitor 37 smooths voltage variation generated in accordance with a switching operation between ON and OFF of each switching element of the second electric power conversion portion 13.

The second electric power conversion portion 13 includes a fourth current sensor 38a and a fifth current sensor 38b. The fourth current sensor 38a is arranged between the β-phase first coil 33 (β1) and the sixth middle point of the third full-bridge circuit 13a. The fifth current sensor 38b is arranged between the β-phase second coil 34 (β2) and the eighth middle point of the fourth full-bridge circuit 13b. For example, the fourth current sensor 38a detects a current that flows through the β-phase first coil 33 (β1). The fifth current sensor 38b detects a current that flows through the β-phase second coil 34 (β2).

The DC charging terminal 14 and the AC charging terminal 15 include, for example, a connection device (connector) or the like for DC electric power and for AC electric power of a predetermined standard. The DC charging terminal 14 and the AC charging terminal 15 are connected, for example, to a DC electric power source (external DC electric power source) and an AC electric power source (external AC electric power source) at the outside on the basis of a commercial electric power source or the like that is connected to an electric power system.

The DC charging terminal 14 is connected to the negative electrode of the second electric power conversion portion 13 and to a middle point (that is, a point between the two transistors connected reversely in series) of each of the first switch 22 and the second switch 32. The AC charging terminal 15 is connected to the fifth middle point of the third full-bridge circuit 13a and to the eighth middle point of the fourth full-bridge circuit 13b. Further, the AC charging terminal 15 is connected to a connection point between the β-phase first coil 33 (β1) and the third connection-disconnection device 35 and is connected to a connection point between the β-phase second coil 34 (β2) and the fourth connection-disconnection device 36.

The rotary electric machine 16 is, for example, a two-phase AC brushless DC motor. As shown in FIG. 2, the rotary electric machine 16 includes, for example, the α-phase first coil 23 (α1), the α-phase second coil 24 (α2), the β-phase first coil 33 (β1), the β-phase second coil 34 (β2), a rotor 41, and a stator core 42. The rotor 41 includes a field permanent magnet. Each coil α1, α2, β1, β2 that generates a rotating magnetic field which rotates the rotor 41 is attached to the stator core 42.

The α-phase first coil 23 (α1), the α-phase second coil 24 (α2), the β-phase first coil 33 (β1), and the β-phase second coil 34 (β2) are so-called open-ended coils, and ends of the coils α1, α2, β1, β2 are not connected to each other (that is, the coils α1, α2, β1, β2 are separated from each other) and are drawn out to the outside of the rotary electric machine 16.

The α-phase first coil 23 (α1) and the α-phase second coil 24 (α2) set, for example, a spatial phase difference from each other to be zero and are wound with respect to the teeth of the stator core 42 in an identical direction when seen from an axis line direction along a center axis O of the rotary electric machine 16. The α-phase first coil 23 (α1) and the α-phase second coil 24 (α2) are arranged, for example, so as to share or respectively occupy part of a slot 43 formed in the stator core 42 and are magnetically coupled to each other in an identical polarity.

The β-phase first coil 33 (β1) and the β-phase second coil 34 (β2) set, for example, a spatial phase difference from each other to be zero and are wound with respect to the teeth of the stator core 42 in an identical direction when seen from the axis line direction along the center axis O of the rotary electric machine 16. The β-phase first coil 33 (β1) and the β-phase second coil 34 (β2) are arranged, for example, so as to share or respectively occupy part of the slot 43 formed in the stator core 42 and are magnetically coupled to each other in an identical polarity.

The α-phase first coil 23 (α1), the α-phase second coil 24 (α2), the β-phase first coil 33 (β1), and the β-phase second coil 34 (β2) are arranged such that the α-phase first coil 23 (α1) and the α-phase second coil 24 (α2) do not magnetically interfere with the β-phase first coil 33 (β1) and the β-phase second coil 34 (β2) by setting the spatial phase difference from each other to be 90°. For example, each coil α1, α2, β1, β2 is attached to the stator core 42 by concentrated winding, distributed winding, or the like.

For example, in the rotary electric machine 16, the β-phase first coil 33 (β1) and the β-phase second coil 34 (β2) are wound around a different slot 43 of an identical phase, and the α-phase first coil 23 (α1) and the α-phase second coil 24 (α2) are wound around an identical slot 43. Specifically, the β-phase first coil 33 (β1) is wound around a first slot SL1 and a second slot SL2, and the β-phase second coil 34 (β2) is wound around a third slot SL3 and a fourth slot SL4. The α-phase first coil 23 (α1) and the α-phase second coil 24 (α2) are wound around the first slot SL1 and the fourth slot SL4 and are also wound around the second slot SL2 and the third slot SL3.

The rotary electric machine 16 generates rotation power by performing a power running operation using electric power that is supplied from the first electric power conversion portion 12 and the second electric power conversion portion 13. For example, when the rotary electric machine 16 is connected to a wheel of a vehicle, the rotary electric machine 16 generates a travel drive force by the electric power that is supplied from the first electric power conversion portion 12 and the second electric power conversion portion 13. The rotary electric machine 16 may generate electric power by performing a regeneration operation using rotation power that is input from a wheel side of the vehicle. For example, when the rotary electric machine 16 is connected to an internal combustion engine of the vehicle, the rotary electric machine 16 may generate electric power using the power of the internal combustion engine.

The gate drive unit 17 switches between ON and OFF of each connection-disconnection device 25, 26, 35, 36 and each switching element of the first electric power conversion portion 12 and the second electric power conversion portion 13 on the basis of a control signal that is received from the electronic control unit 18. For example, the gate drive unit 17 switches between ON and OFF of each switching element of each full-bridge circuit 12a, 12b, 13a, 13b by outputting a gate signal generated by amplification, level shift, and the like of the control signal.

The position sensor 19 detects a rotation angle of the rotor 41 of the rotary electric machine 16 as a rotor angle θ and outputs an analog signal indicating a detection result of the rotor angle θ to the electronic control unit 18. For example, the position sensor 19 is a resolver that is attached to a rotor shaft (not shown) of the rotary electric machine 16.

The electronic control unit 18 integrally controls an operation of each of the electric power control unit 10a and the rotary electric machine 16. For example, the electronic control unit 18 is a software function unit that functions by a predetermined program being executed by a processor such as a CPU (Central Processing Unit). The software function unit is an ECU (Electronic Control Unit) that includes the processor such as a CPU, a ROM (Read Only Memory) that stores the program, a RAM (Random Access Memory) that temporarily stores data, and an electronic circuit such as a timer. At least part of the electronic control unit 18 may be an integrated circuit such as a LSI (Large Scale Integration).

The electronic control unit 18 generates a control signal indicating a timing when each connection-disconnection device 25, 26, 35, 36 and each switching element of the first electric power conversion portion 12 and the second electric power conversion portion 13 are driven to ON and OFF. The electronic control unit 18 outputs the generated control signal to the gate drive unit 17.

### Control Operation Of Electric Apparatus

The electronic control unit 18 sets the first connection-disconnection device 25 and the second connection-disconnection device 26 to be in an ON state in the case of the power running operation or the regeneration operation of the rotary electric machine 16. The electronic control unit 18 switches between a state in which the α-phase coils α1, α2 are connected in series and the β-phase coils β1, β2 are connected in series, and a state in which the α-phase coils α1, α2 are connected in parallel and the β-phase coils β1, β2 are connected in parallel by the switching between ON and OFF of the first switch 22 and the second switch 32.

The electronic control unit 18 performs, for example, a feedback control or the like of a current in which a current detection value of the rotary electric machine 16 and a current target value in response to a torque command value of the rotary electric machine 16 are used and generates a control signal that commands the driving of each switching element of the first electric power conversion portion 12 and the second electric power conversion portion 13.

At the time of DC charging, that is, when the electric power storage device 11 is charged by the external DC electric power source that is connected to the DC charging terminal 14, the electronic control unit 18 sets the first connection-disconnection device 25 and the second connection-disconnection device 26 to be in an ON state. The electronic control unit 18 causes each of the combination of the α-phase coils α1, α2 and the first electric power conversion portion 12 and the combination of the β-phase coils β1, β2 and the second electric power conversion portion 13 to function as a non-insulation type DC-DC converter that performs a voltage increase operation by a so-called chopper control, for example, with respect to the external DC electric power source having a lower voltage than that of the electric power storage device 11.

At the time of AC charging, that is, when the electric power storage device 11 is charged by the external AC electric power source that is connected to the AC charging terminal 15, the electronic control unit 18 sets the first connection-disconnection device 25 and the second connection-disconnection device 26 to be in an OFF state for insulation.

The electronic control unit 18 sets, for example, the α-phase first coil 23 (α1) and the α-phase second coil 24 (α2) that are magnetically coupled to each other in the identical polarity to be a coil of a DC conversion phase (α phase) used for conversion between DC electric power. The electronic control unit 18 causes, for example, the combination of the α-phase coils α1, α2 and the first electric power conversion portion 12 to function as a DAB (Dual Active Bridge) type DC-DC converter which is an insulation-type bidirectional (voltage increase and voltage decrease) converter.

The electronic control unit 18 sets, for example, the β-phase first coil 33 (β1) and the β-phase second coil 34 (β2) that are magnetically coupled to each other in the identical polarity to be a coil of an AC input phase (β phase) that is connected to the external AC electric power source. The electronic control unit 18 causes, for example, the combination of the β-phase coils β1, β2 and the second electric power conversion portion 13 to function as a so-called full-bridgeless type (or bridgeless and totem pole type) power factor correction (PFC) circuit which converts AC electric power into DC electric power. The so-called bridgeless PFC is a PFC that does not include a bridge rectifier by a plurality of diodes which are connected by bridge connection. The totem pole PFC is a PFC that includes a pair of switching elements of an identical conductivity type which are connected (totem pole connection) in series in an identical direction. The electronic control unit 18 performs the power factor correction of an input voltage Vac and an input current Iac while performing rectification of AC electric power that is received from the external AC electric power source into DC electric power and increasing the voltage, for example, by controlling the switching of each switching element in each full-bridge circuit 13a, 13b of the second electric power conversion portion 13.

Hereinafter, an operation of the electronic control unit 18 at the time of DC charging is described in detail.

At the time of DC charging, when a first condition is satisfied, the electronic control unit 18 performs charging by using the α-phase coil (first coil). The α-phase coil includes the α-phase first coil 23 (α1) and the α-phase second coil 24 (α2). The first condition will be described later. In the following description, performing of the charging by using the α-phase coil may be referred to as “α-phase charging”.

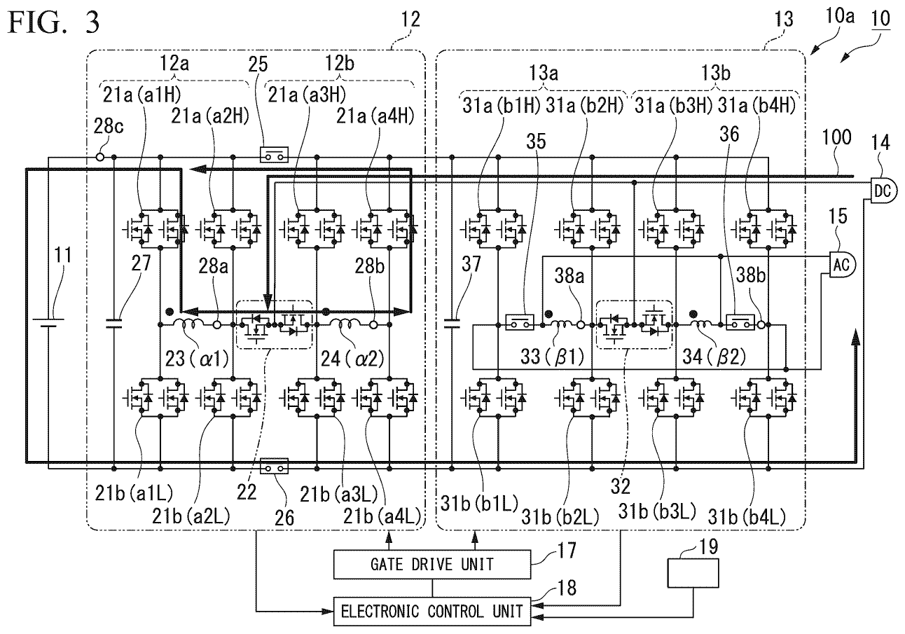

FIG. 3 is a view showing a path 100 of a charging current that flows in the electric apparatus 10 when the α-phase charging is performed. When performing the α-phase charging, the electronic control unit 18 controls the first full-bridge circuit 12a and the second full-bridge circuit 12b such that the α-phase first coil 23 (α1) and the α-phase second coil 24 (α2) are included in the path 100 of the charging current. More specifically, when performing the α-phase charging, the electronic control unit 18 generates a control signal that causes the element portions a1H, a4H to be in an ON state and causes the element portions a2H, a3H, a1L, a2L, a3L, a4L to be in an OFF state.

Further, when performing the α-phase charging, the electronic control unit 18 controls the third full-bridge circuit 13a and the fourth full-bridge circuit 13b such that the β-phase first coil 33 (β1) and the β-phase second coil 34 (β2) are not included in the path 100 of the charging current. More specifically, when performing the α-phase charging, the electronic control unit 18 generates a control signal that causes the element portions b1H, b2H, b3H, b4H, b1L, b2L, b3L, b4L to be in an OFF state.

As described above, the electronic control unit 18 controls each full-bridge circuit, and thereby, the charging current flows through the path 100 shown in FIG. 3. As shown in FIG. 3, when the α-phase charging is performed, the charging current that flows into the first switch 22 from the positive electrode of the DC charging terminal 14 is divided into a current that passes through the α-phase first coil 23 (α1), the element portion a1H, and the electric power storage device 11 and returns to the negative electrode of the DC charging terminal 14 and a current that passes through the α-phase second coil 24 (α2), the element portion a4H, and the electric power storage device 11 and returns to the negative electrode of the DC charging terminal 14.

At the time of DC charging, when a second condition is satisfied, the electronic control unit 18 performs charging by using the β-phase coil (second coil). The β-phase coil includes the β-phase first coil 33 (β1) and the β-phase second coil 34 (β2). The second condition will be described later. In the following description, performing of the charging by using the β-phase coil may be referred to as “β-phase charging”.

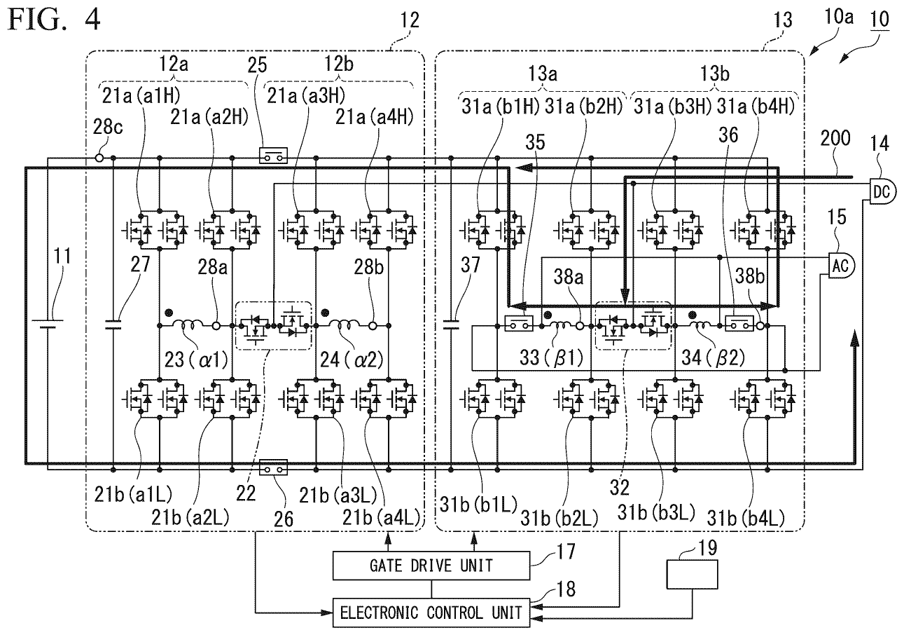

FIG. 4 is a view showing a path 200 of a charging current that flows in the electric apparatus 10 when the β-phase charging is performed. When performing the β-phase charging, the electronic control unit 18 controls the third full-bridge circuit 13a and the fourth full-bridge circuit 13b such that the β-phase first coil 33 (β1) and the β-phase second coil 34 (β2) are included in the path 200 of the charging current. More specifically, when performing the β-phase charging, the electronic control unit 18 generates a control signal that causes the element portions b1H, b4H to be in an ON state and causes the element portions b2H, b3H, b1L, b2L, b3L, b4L to be in an OFF state.

Further, when performing the β-phase charging, the electronic control unit 18 controls the first full-bridge circuit 12a and the second full-bridge circuit 12b such that the α-phase first coil 23 (α1) and the α-phase second coil 24 (α2) are not included in the path 200 of the charging current. More specifically, when performing the β-phase charging, the electronic control unit 18 generates a control signal that causes the element portions a1H, a2H, a3H, a4H, a1L, a2L, a3L, a4L to be in an OFF state.

As described above, the electronic control unit 18 controls each full-bridge circuit, and thereby, the charging current flows through the path 200 shown in FIG. 4. As shown in FIG. 4, when the β-phase charging is performed, the charging current that flows into the second switch 32 from the positive electrode of the DC charging terminal 14 is divided into a current that passes through the β-phase first coil 33 (β1), the element portion b1H, and the electric power storage device 11 and returns to the negative electrode of the DC charging terminal 14 and a current that passes through the β-phase second coil 34 (β2), the element portion b4H, and the electric power storage device 11 and returns to the negative electrode of the DC charging terminal 14.

At the time of DC charging, when a third condition is satisfied, the electronic control unit 18 performs charging by using both of the α-phase coil and the β-phase coil. The third condition will be described later. In the following description, performing of the charging by using both of the α-phase coil and the β-phase coil may be referred to as “two-phase charging”.

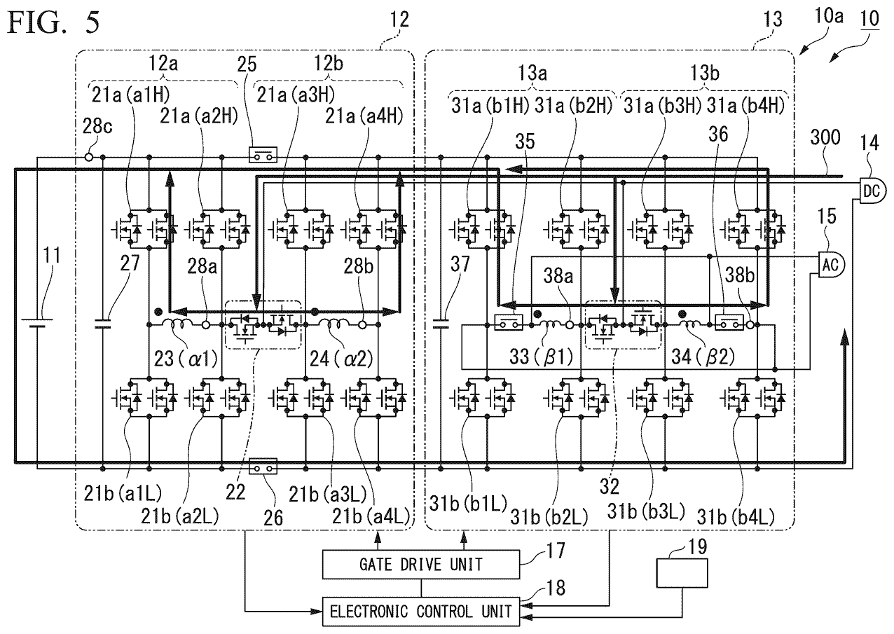

FIG. 5 is a view showing a path 300 of a charging current that flows in the electric apparatus 10 when the two-phase charging is performed. When performing the two-phase charging, the electronic control unit 18 controls the first full-bridge circuit 12a and the second full-bridge circuit 12b such that the α-phase first coil 23 (α1) and the α-phase second coil 24 (α2) are included in the path 300 of the charging current. More specifically, when performing the two-phase charging, the electronic control unit 18 generates a control signal that causes the element portions a1H, a4H to be in an ON state and causes the element portions a2H, a3H, a1L, a2L, a3L, a4L to be in an OFF state.

Further, when performing the two-phase charging, the electronic control unit 18 controls the third full-bridge circuit 13a and the fourth full-bridge circuit 13b such that the β-phase first coil 33 (β1) and the β-phase second coil 34 (β2) are included in the path 300 of the charging current. More specifically, when performing the two-phase charging, the electronic control unit 18 generates a control signal that causes the element portions b1H, b4H to be in an ON state and causes the element portions b2H, b3H, b1L, b2L, b3L, b4L to be in an OFF state.

As described above, the electronic control unit 18 controls each full-bridge circuit, and thereby, the charging current flows through the path 300 shown in FIG. 5. As shown in FIG. 5, when the two-phase charging is performed, the charging current that flows into the first switch 22 from the positive electrode of the DC charging terminal 14 is divided into a current that passes through the α-phase first coil 23 (α1), the element portion a1H, and the electric power storage device 11 and returns to the negative electrode of the DC charging terminal 14 and a current that passes through the α-phase second coil 24 (α2), the element portion a4H, and the electric power storage device 11 and returns to the negative electrode of the DC charging terminal 14.

Further, as shown in FIG. 5, when the two-phase charging is performed, the charging current that flows into the second switch 32 from the positive electrode of the DC charging terminal 14 is divided into a current that passes through the β-phase first coil 33 (β1), the element portion b1H, and the electric power storage device 11 and returns to the negative electrode of the DC charging terminal 14 and a current that passes through the β-phase second coil 34 (β2), the element portion b4H, and the electric power storage device 11 and returns to the negative electrode of the DC charging terminal 14.

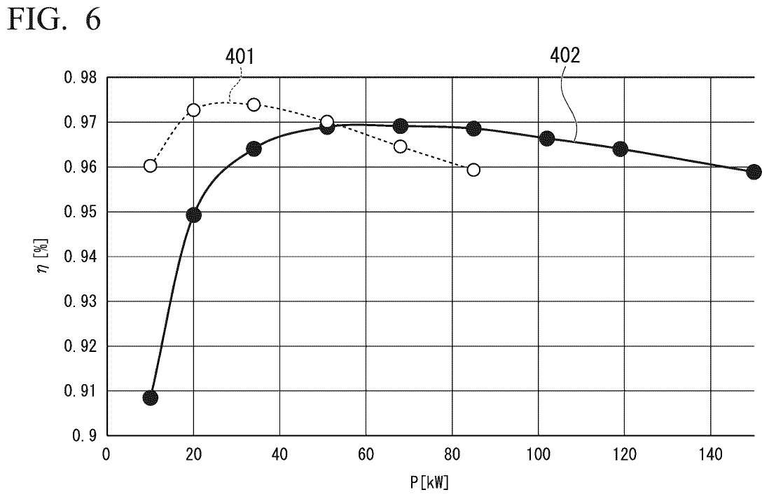

FIG. 6 is a view showing a correspondence relationship between charging electric power P and a charging efficiency η. In FIG. 6, a curve 401 indicates a change in the charging efficiency η with respect to the charging electric power P when the α-phase charging is performed, and a curve 402 indicates a change in the charging efficiency η with respect to the charging electric power P when the two-phase charging is performed. Although not shown in FIG. 6, a change in the charging efficiency η with respect to the charging electric power P when the β-phase charging is performed is also a change similar to the curve 401.

As shown in FIG. 6, when the α-phase charging (or the β-phase charging) is performed, the charging efficiency η is relatively high in a region (a region where an iron loss becomes dominant) where the charging electric power P is relatively low, and the charging efficiency η is relatively low in a region (a region where a copper loss becomes dominant) where the charging electric power P is relatively high. On the other hand, when the two-phase charging is performed, the charging efficiency η is relatively low in a region (a region where the iron loss becomes dominant) where the charging electric power P is relatively low, and the charging efficiency η is relatively high in a region (a region where the copper loss becomes dominant) where the charging electric power P is relatively high. With reference to data shown in FIG. 6, it is understood that a high charging efficiency η can be maintained over the entire region of the charging electric power P by performing the α-phase charging or the β-phase charging in the region where the charging electric power P is relatively low and performing the two-phase charging in the region where the charging electric power P is relatively high.

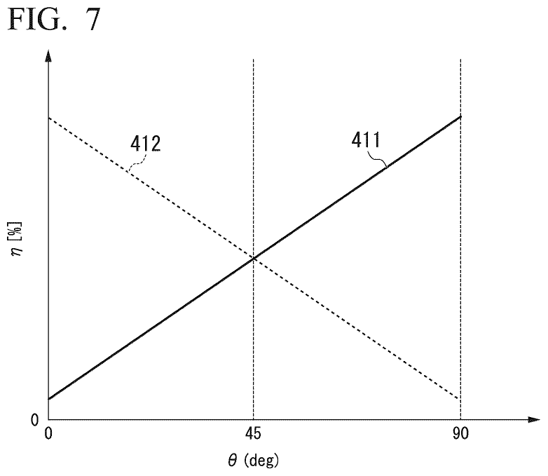

FIG. 7 is a view showing a correspondence relationship between a rotor angle θ and a charging efficiency η. In FIG. 7, a straight line 411 indicates a change in the charging efficiency η with respect to the rotor angle θ when the α-phase charging is performed, and a straight line 412 indicates a change in the charging efficiency η with respect to the rotor angle θ when the β-phase charging is performed.

As shown in FIG. 7, when the rotor angle θ is less than 45 degrees, the charging efficiency of the β-phase charging is higher than the charging efficiency of the α-phase charging, and when the rotor angle θ is equal to or more than 45 degrees, the charging efficiency of the α-phase charging is higher than the charging efficiency of the β-phase charging. With reference to data shown in FIG. 7, it is understood that a high charging efficiency η can be maintained over the entire region of the rotor angle θ by performing the β-phase charging in a region where the rotor angle θ is relatively low and performing the α-phase charging in a region where the rotor angle θ is relatively high.

In the present embodiment, the first condition, the second condition, and the third condition are set based on the data shown in FIG. 6 and FIG. 7 as described above.

For example, the first condition is a condition that “the charging electric power P is less than an electric power threshold value P1, and the rotor angle θ is equal to or more than an angle threshold value θ1”. That is, the electronic control unit 18 performs the α-phase charging when the first condition in which the charging electric power P is less than the electric power threshold value P1, and the rotor angle θ is equal to or more than the angle threshold value θ1 is satisfied.

For example, the second condition is a condition that “the charging electric power P is less than the electric power threshold value P1, and the rotor angle θ is less than the angle threshold value θ1”. That is, the electronic control unit 18 performs the β-phase charging when the second condition in which the charging electric power P is less than the electric power threshold value P1, and the rotor angle θ is less than the angle threshold value θ1 is satisfied.

For example, the third condition is a condition that “the charging electric power P is equal to or more than the electric power threshold value P1”. That is, the electronic control unit 18 performs the two-phase charging when the third condition in which the charging electric power P is equal to or more than the electric power threshold value P1 is satisfied.

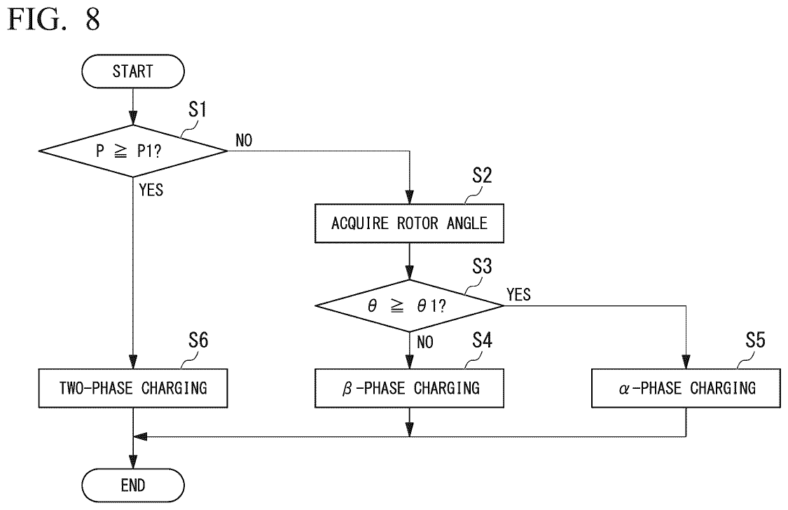

In light of the above description, hereinafter, a charging control process performed by the electronic control unit 18 at the time of DC charging is described with reference to FIG. 8. FIG. 8 is a flowchart showing a charging control process performed by the electronic control unit 18 at the time of DC charging.

As shown in FIG. 8, when the charging control process is started, first, the electronic control unit 18 determines whether or not the charging electric power P is equal to or more than the electric power threshold value P1 (Step S1).

When the charging electric power P is less than the electric power threshold value P1 (Step S1: NO), the electronic control unit 18 acquires the rotor angle θ based on an output signal of the position sensor 19 (Step S2).

After acquiring the rotor angle θ, the electronic control unit 18 determines whether or not the rotor angle θ is equal to or more than the angle threshold value θ1 (Step S3).

When the rotor angle θ is less than the angle threshold value θ1 (Step S3: NO), the electronic control unit 18 performs the β-phase charging (Step S4).

On the other hand, when the rotor angle θ is equal to or more than the angle threshold value θ1 (Step S3: YES), the electronic control unit 18 performs the α-phase charging (Step S5).

When the charging electric power P is equal to or more than the electric power threshold value P1 (Step S1: YES), the electronic control unit 18 performs the two-phase charging (Step S6).

As described above, in the electric apparatus 10 of the present embodiment, the electronic control unit 18 controls a first full-bridge circuit (the first full-bridge circuit 12a and the second full-bridge circuit 12b) and a second full-bridge circuit (the third full-bridge circuit 13a and the fourth full-bridge circuit 13b) such that electric power is supplied to one of the α-phase coil and the β-phase coil based on the rotor angle θ obtained from an output signal of the position sensor 19 at the time of DC charging. Thereby, the electric power storage device 11 can be charged by using a coil of a phase having a relatively high charging efficiency among the α-phase coil and the β-phase coil in accordance with the rotor angle θ of the rotary electric machine 16, and therefore, it is possible to improve the charging efficiency at the time of DC charging.

Further, in the present embodiment, the α-phase coil is constituted by connecting the α-phase first coil 23 (α1) and the α-phase second coil 24 (α2) in series in a state where the α-phase first coil 23 (α1) and the α-phase second coil 24 (α2) are coupled in and identical direction, the β-phase coil is constituted by connecting the β-phase first coil 33 (β1) and the β-phase second coil 34 (β2) in series in a state where the β-phase first coil 33 (β1) and the β-phase second coil 34 (β2) are coupled in an identical direction, the positive electrode of the DC charging terminal 14 is connected to each of a connection point between the α-phase first coil 23 (α1) and the α-phase second coil 24 (α2) and a connection point between the β-phase first coil 33 (β1) and the β-phase second coil 34 (β2), and the negative electrode of the DC charging terminal 14 is connected to the negative electrode of the electric power storage device 11. Thereby, since an iron loss is reduced by a current flowing in a direction in which each of the α-phase coil and the β-phase coil cancels a magnetic flux, the charging efficiency is improved, and it is possible to prevent a charging torque from being generated.

Further, in the present embodiment, at a time of the DC charging, the electronic control unit 18 controls the first full-bridge circuit and the second full-bridge circuit such that electric power is supplied to both of the α-phase coil and the β-phase coil when charging electric power P is equal to or more than an electric power threshold value P1 and controls the first full-bridge circuit and the second full-bridge circuit such that electric power is supplied to one of the α-phase coil and the β-phase coil when the charging electric power P is less than the electric power threshold value P1. Thereby, since charging is performed by supplying electric power to one of the α-phase coil and the β-phase coil in a region where the charging electric power is relatively low, and charging is performed by supplying electric power to both of the α-phase coil and the β-phase coil in a region where the charging electric power is relatively high, it is possible to maintain a high charging efficiency over the entire region of the charging electric power.

Further, in the present embodiment, the α-phase coil is constituted of the α-phase first coil 23 (α1) and the α-phase second coil 24 (α2) in which a middle point of the α-phase coil is a boundary, and the α-phase first coil 23 (α1) and the α-phase second coil 24 (α2) are wound around an identical slot in the rotary electric machine 16. In this way, by employing a structure in which the α-phase first coil 23 (α1) and the α-phase second coil 24 (α2) are wound around the identical slot in the rotary electric machine 16, a magnetic coupling degree between the α-phase first coil 23 (α1) and the α-phase second coil 24 (α2) can be enhanced, and therefore, it is possible to improve the charging efficiency.

Further, in the present embodiment, the β-phase coil is constituted of the β-phase first coil 33 (β1) and the β-phase second coil 34 (β2) in which a middle point of the β-phase coil as a boundary, the β-phase first coil 33 (β1) and the β-phase second coil 34 (β2) are wound around a different slot of an identical phase in the rotary electric machine 16, and when controlling the first full-bridge circuit and the second full-bridge circuit such that electric power is supplied to the β-phase coil among the α-phase coil and the β-phase coil at the time of DC charging, the electronic control unit 18 controls the first full-bridge circuit and the second full-bridge circuit such that a current flows in a direction in which a magnetic field is cancelled with respect to the rotor 41. Thereby, it is possible to prevent a charging torque from being generated at the rotary electric machine 16 while structurally ensuring the inductance of the rotary electric machine 16.

Although an embodiment of the present invention has been described, the present invention is not limited to the embodiment described above, and various modifications and substitutions can be made without departing from the scope of the present invention.

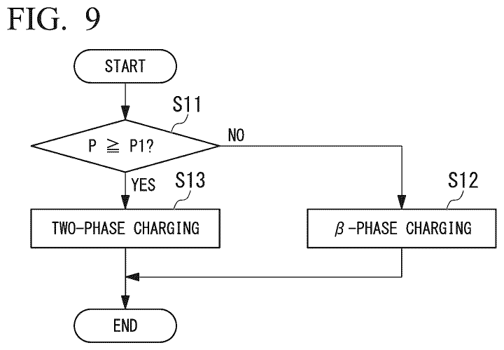

For example, the embodiment is described using an example in which the electronic control unit 18 performs the α-phase charging when the first condition is satisfied, performs the β-phase charging when the second condition is satisfied, and performs the two-phase charging when the third condition is satisfied. On the other hand, for example, as shown in FIG. 9, the electronic control unit 18 may perform the two-phase charging when the third condition is satisfied and may perform one of the α-phase charging and the β-phase charging when the third condition is not satisfied.

FIG. 9 is a flowchart showing a modification example of a charging control process performed by the electronic control unit 18 at the time of DC charging.

As shown in FIG. 9, when starting the charging control process, first, the electronic control unit 18 determines whether or not the charging electric power P is equal to or more than the electric power threshold value P1 (Step S11).

When the charging electric power P is less than the electric power threshold value P1 (Step S11: NO), the electronic control unit 18 performs the β-phase charging (Step S12). In Step S12, the electronic control unit 18 may perform the α-phase charging instead of the β-phase charging.

On the other hand, when the charging electric power P is equal to or more than the electric power threshold value P1 (Step S11: YES), the electronic control unit 18 performs the two-phase charging (Step S13).

In the modification example described above, at the time of DC charging, the electronic control unit 18 controls the first full-bridge circuit and the second full-bridge circuit such that electric power is supplied to both of the α-phase coil and the β-phase coil when charging electric power P is equal to or more than the electric power threshold value P1 and controls the first full-bridge circuit and the second full-bridge circuit such that electric power is supplied to one of the α-phase coil and the β-phase coil when the charging electric power P is less than the electric power threshold value P1. Thereby, since charging is performed by supplying electric power to one of the α-phase coil and the β-phase coil in a region where the charging electric power is relatively low, and charging is performed by supplying electric power to both of the α-phase coil and the β-phase coil in a region where the charging electric power is relatively high, it is possible to maintain a high charging efficiency over the entire region of the charging electric power.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and the gist of the invention and are also included within the scope of the invention described in the appended claims and equivalents thereof.

What is claimed is:

1. An electric apparatus comprising:
an electric power storage device;
a rotary electric machine;
an electric power control unit that is connected to the electric power storage device and the rotary electric machine and controls electric power transfer of each of the electric power storage device and the rotary electric machine;
a DC charging terminal that connects the electric power control unit to an external DC electric power source; and
a position sensor that detects a rotation angle of a rotor of the rotary electric machine as a rotor angle,
wherein the rotary electric machine comprises a first coil and a second coil that have a phase which is orthogonal to each other,
the electric power control unit comprises
a first full-bridge circuit connected to both ends of the first coil,
a second full-bridge circuit connected to both ends of the second coil, and
a control device that controls the first full-bridge circuit and the second full-bridge circuit, and
the control device controls the first full-bridge circuit and the second full-bridge circuit such that electric power is supplied to one of the first coil and the second coil based on the rotor angle obtained from an output signal of the position sensor at a time of DC charging in which the electric power storage device is charged by electric power supplied from the external DC electric power source.

2. The electric apparatus according to claim 1,
wherein the first coil is constituted by connecting a third coil and a fourth coil in series in a state where the third coil and the fourth coil are coupled in an identical direction,
the second coil is constituted by connecting a fifth coil and a sixth coil in series in a state where the fifth coil and the sixth coil are coupled in an identical direction,
a positive electrode of the DC charging terminal is connected to each of a connection point between the third coil and the fourth coil and a connection point between the fifth coil and the sixth coil, and
a negative electrode of the DC charging terminal is connected to a negative electrode of the electric power storage device.

3. The electric apparatus according to claim 1,
wherein at the time of the DC charging, the control device
controls the first full-bridge circuit and the second full-bridge circuit such that electric power is supplied to both of the first coil and the second coil when charging electric power is equal to or more than an electric power threshold value and
controls the first full-bridge circuit and the second full-bridge circuit such that electric power is supplied to one of the first coil and the second coil when the charging electric power is less than the electric power threshold value.

4. The electric apparatus according to claim 1,
wherein the first coil is constituted of the third coil and the fourth coil in which a middle point of the first coil is a boundary, and
the third coil and the fourth coil are wound around an identical slot in the rotary electric machine.

5. The electric apparatus according to claim 4,
wherein the second coil is constituted of the fifth coil and the sixth coil in which a middle point of the second coil is a boundary,
the fifth coil and the sixth coil are wound around a different slot of an identical phase in the rotary electric machine, and
when controlling the first full-bridge circuit and the second full-bridge circuit such that electric power is supplied to the second coil among the first coil and the second coil at the time of DC charging, the control device controls the first full-bridge circuit and the second full-bridge circuit such that a current flows in a direction in which a magnetic field is cancelled with respect to the rotor.

6. The electric apparatus according to claim 2,
wherein the first coil is constituted of the third coil and the fourth coil in which a middle point of the first coil is a boundary, and
the third coil and the fourth coil are wound around an identical slot in the rotary electric machine.

7. The electric apparatus according to claim 6,
wherein the second coil is constituted of the fifth coil and the sixth coil in which a middle point of the second coil is a boundary,
the fifth coil and the sixth coil are wound around a different slot of an identical phase in the rotary electric machine, and
when controlling the first full-bridge circuit and the second full-bridge circuit such that electric power is supplied to the second coil among the first coil and the second coil at the time of DC charging, the control device controls the first full-bridge circuit and the second full-bridge circuit such that a current flows in a direction in which a magnetic field is cancelled with respect to the rotor.

8. The electric apparatus according to claim 3,
wherein the first coil is constituted of the third coil and the fourth coil in which a middle point of the first coil is a boundary, and
the third coil and the fourth coil are wound around an identical slot in the rotary electric machine.

9. The electric apparatus according to claim 8,
wherein the second coil is constituted of the fifth coil and the sixth coil in which a middle point of the second coil is a boundary,
the fifth coil and the sixth coil are wound around a different slot of an identical phase in the rotary electric machine, and
when controlling the first full-bridge circuit and the second full-bridge circuit such that electric power is supplied to the second coil among the first coil and the second coil at the time of DC charging, the control device controls the first full-bridge circuit and the second full-bridge circuit such that a current flows in a direction in which a magnetic field is cancelled with respect to the rotor.

10. An electric apparatus comprising:
an electric power storage device;
a rotary electric machine;
an electric power control unit that is connected to the electric power storage device and the rotary electric machine and controls electric power transfer of each of the electric power storage device and the rotary electric machine; and
a DC charging terminal that connects the electric power control unit to an external DC electric power source,
wherein the rotary electric machine comprises a first coil and a second coil that have a phase which is orthogonal to each other,
the electric power control unit comprises
a first full-bridge circuit connected to both ends of the first coil,
a second full-bridge circuit connected to both ends of the second coil, and
a control device that controls the first full-bridge circuit and the second full-bridge circuit, and
at a time of the DC charging in which the electric power storage device is charged by electric power supplied from the external DC electric power source, the control device
controls the first full-bridge circuit and the second full-bridge circuit such that electric power is supplied to both of the first coil and the second coil when charging electric power is equal to or more than an electric power threshold value and
controls the first full-bridge circuit and the second full-bridge circuit such that electric power is supplied to one of the first coil and the second coil when the charging electric power is less than the electric power threshold value.
